(19) United States
(12) Patent Application Publication
(10) Pub. No.: US 2006/0130670 A1
(43) Pub. Date: Jun. 22, 2006

(54) Multiple fryer types in unitary cabinet

(75) Inventors: Jarrad Andrew Johnson, Bossier City, LA (US); Charles Milton Hutchinson, Shreveport, LA (US); Robert Jack Bonnette III, Shreveport, LA (US)

Correspondence Address: Paul D Greeley, Esq.;Ohlandt, Greeley, Ruggiero & Perle, L.L.P., 10th Floor, One Landmark Square, Stamford, CT, 06901-2682, US

(73) Assignee: THE FRYMASTER CORPORATION

(21) Appl. No.: 11/294,144

(22) Filed: Dec. 5, 2005

Related U.S. Application Data
(60) Provisional application No. 60/637,074, filed on Dec. 17, 2004.

(51) Int. Cl. A47J 37/12

(52) U.S. Cl. 99/403

(57) ABSTRACT

A unitary housing for food preparation having a plurality of types of food fryers operably connected in the unitary housing is provided. The housing is configured to integrate each of the plurality of types of food fryers into the unitary housing. A unitary housing system for food preparation having a plurality of types of food fryers are operably connected in a unitary housing system is provided. The unitary housing system further includes a filter pan operably positioned for use with each of said plurality of types of food fryers and at least one work surface; wherein housing system is configured to integrate each of the plurality of types of food fryers and at least one work surface into the unitary housing system.

This application claims the benefit of U.S. Provisional Patent Application Ser. No. 60/637,074, filed on Dec. 17, 2004, the contents of which are incorporated by reference herein.

### FIELD OF THE INVENTION

This invention relates to a single unitary cabinet structure that combines multiple fryer types into a single appliance.

### BACKGROUND OF THE INVENTION

In the commercial food industry, and in particular, in the fast food industry, frying equipment is frequently used. Fryers are of a variety of types, for example, open pot fryers, tube pot fryers and flat bottom fryers. Currently, when these different types of fryers are used in a single kitchen they must be individually purchased. Depending upon a customer's order, a fryer must be installed when it is needed and disconnected when another type of fryer is required for an order. Further, fryers purchased from different vendors having different plumbing systems, filters, electronic systems and appearances.

Utilizing individual fryers of different types is not only cost prohibitive, but it is also highly cumbersome, inefficient and unattractive. Accordingly, there is a need for a single cabinet structure that integrates different types of fryers into a single unitary cabinet having common plumbing and electronic systems to prevent the purchaser from having to purchase multiple individual units.

### SUMMARY OF THE INVENTION

A unitary housing for food preparation having a plurality of types of food fryers operably connected in the unitary housing. The housing is configured to integrate each of the plurality of types of food fryers into the unitary housing.

A unitary housing system for food preparation having a plurality of types of food fryers operably connected in a unitary housing system and at least one work surface. The unitary housing system further includes a filter pan operably positioned for use with each of the plurality of types of food fryers; wherein the housing system is configured to integrate each of the plurality of types of food fryers into the unitary housing system.

The above-described and other features and advantages of the present disclosure will be appreciated and understood by those skilled in the art from the following detailed description, drawings, and appended claims.

### BRIEF DESCRIPTION OF THE DRAWINGS

Other and further object, advantages and features of the present invention will be understood by reference to the following specification in conjunction with the accompanying drawings, in which like reference characters denote like elements of structure and:

FIG. 1 illustrates a front view of a frying battery of a first embodiment of the present invention incorporating two different styles of fryers into a single unitary fryer cabinet;

FIG. 2 illustrates is a top view of the frying battery of FIG. 1;

FIG. 3 illustrates is a side view of the frying battery of FIG. 1;

FIG. 4 illustrates is a front perspective view of the frying battery of FIG. 1;

FIG. 5 illustrates is a rear perspective view of the frying battery of FIG. 1;

FIG. 6 is a photograph of the frying battery of FIGS. 1 through 5;

FIG. 7 illustrates is a front view of a frying battery of a second embodiment of the present invention incorporating two different styles of fryers into a single unitary fryer cabinet;

FIG. 8 illustrates is a top view of the frying battery of FIG. 7;

FIG. 9 illustrates is a side view of the frying battery of FIG. 7;

FIG. 10 illustrates a front view of a frying battery of a third embodiment of the present invention incorporating two different styles of fryers into a single unitary fryer cabinet;

FIG. 11 illustrates is a top view of the frying battery of FIG. 10;

FIG. 12 illustrates is a side view of the frying battery of FIG. 10;

FIG. 13 illustrates a top view of a frying battery of a fourth embodiment of the present invention incorporating a work surface into a single unitary fryer cabinet;

FIG. 14 illustrates a front view of the frying battery of FIG. 13;

FIG. 15 illustrates a side view of the frying battery of FIG. 13;

FIG. 16 is a photograph of a frying battery of a fifth embodiment of the present invention that incorporates two different styles of fryers into a single unitary cabinet; and

FIG. 17 is a photograph of a frying battery of a sixth embodiment of the present invention that incorporates two different fryers into a single unitary cabinet.

### DESCRIPTION OF THE PREFERRED EMBODIMENT

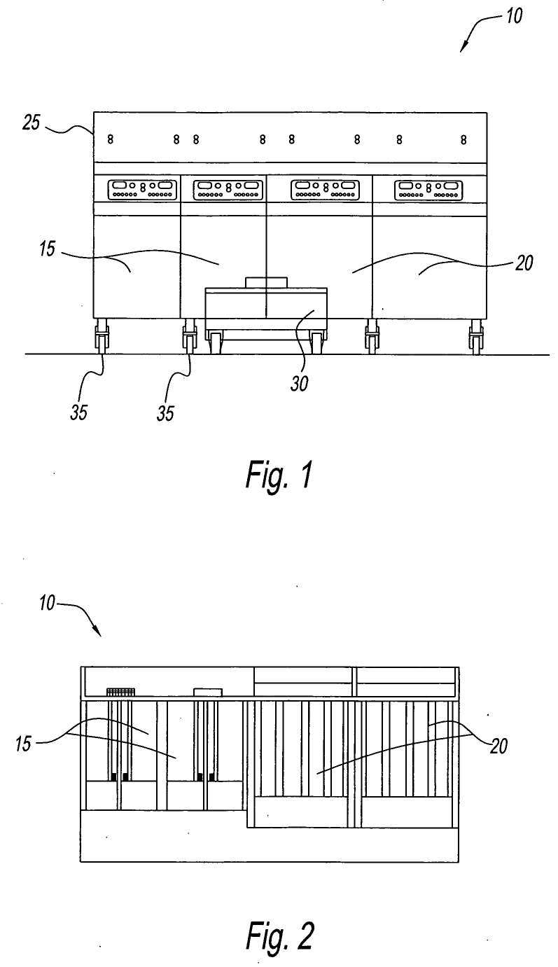

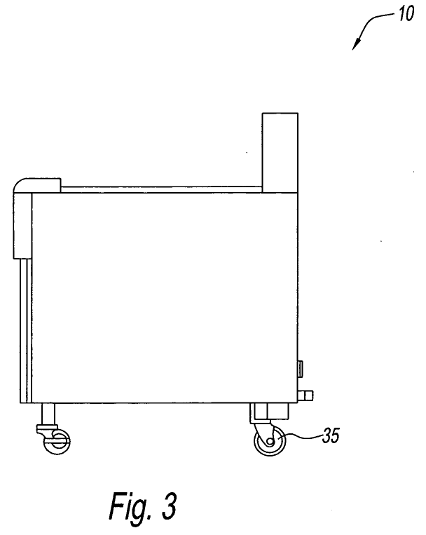

Referring to FIGS. 1 through 3, a first embodiment of the fryer battery 10 of the present invention includes two types of fryer types 15 and 20 disposed side by side in a single unitary cabinet structure 25. The four fryers of the first configuration have individual flues (not shown). The two adjacent fryer types 15 and 20 are integrated into a single cabinet structure 25 and share a common filter, electronic system and plumbing system. The single unitary structure 25 offers a sleek appearance to the commercial kitchen, saves space, and prevents the purchaser from having to purchase multiple individual units. The cabinet structure 25 is placed on casters 35 for easy relocation within a commercial kitchen. Filter pan 30 is movable on casters beneath to collect used oil from frypots 15 and 20.

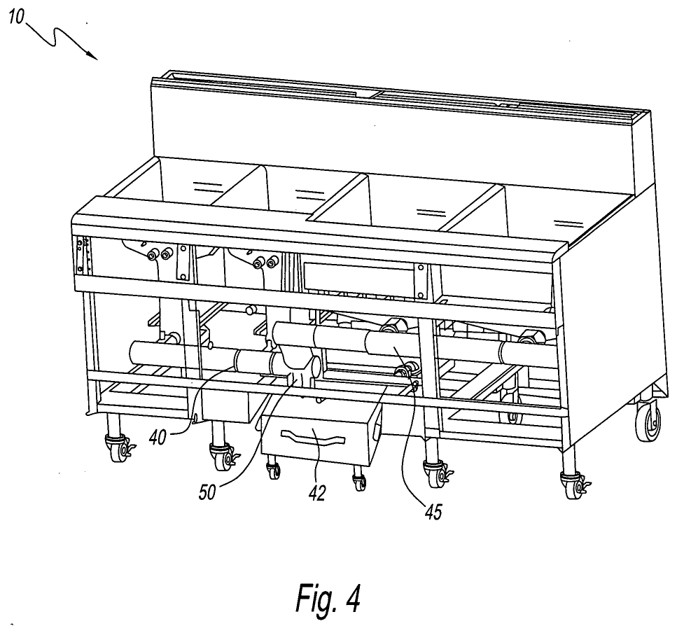

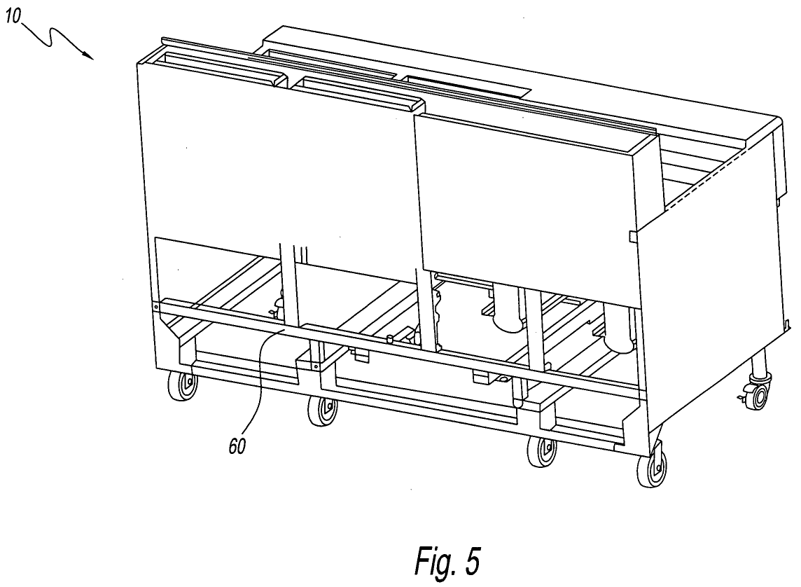

The first embodiment includes fryer type 15 that are two open pot fryers adjacent to two fryer types 20 that are tube pot fryers. Open pot fryers and tube pot fryers area used in the commercial food industry to cook different types of foods. Open pot fryers are used to cook foods with little or no breading and tube pot fryers are used to cook more heavily breaded foods. The different functions of the two styles of fryers require different plumbing orientations and different sized pots. In order for the two different pot styles to be combined into a single unitary cabinet, the plumbing and piping fixtures must be aligned and synchronized to function properly and efficiently. Referring to FIG. 4, pipes 40 and 45 allow used frying oil to flow to common hub or down spout 50 before reaching filter 42. Additionally, structural components have been changed in order to provide universal frypot support for all fry pots. Mechanical operation of handles, valves, and switches have been redesigned to be common among all types of frypots. This commonality provides for many benefits to the operator including improved and quicker draining, easier filtering, space savings, and greater reliability. Similarly, in FIG. 5, a common oil return manifold 60 is used to provide space savings, more efficient cooking operations and greater reliability.

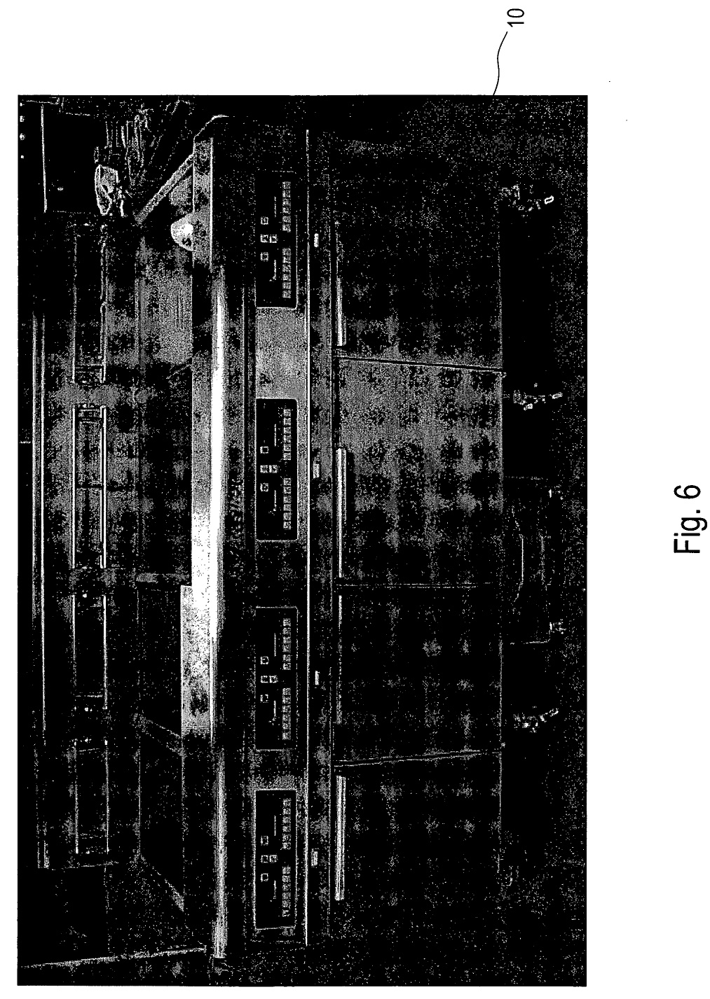

FIG. 6 is a photograph of the first embodiment showing how such a unitary cabinet structure incorporating a battery of combined fryers would look in a commercial setting.

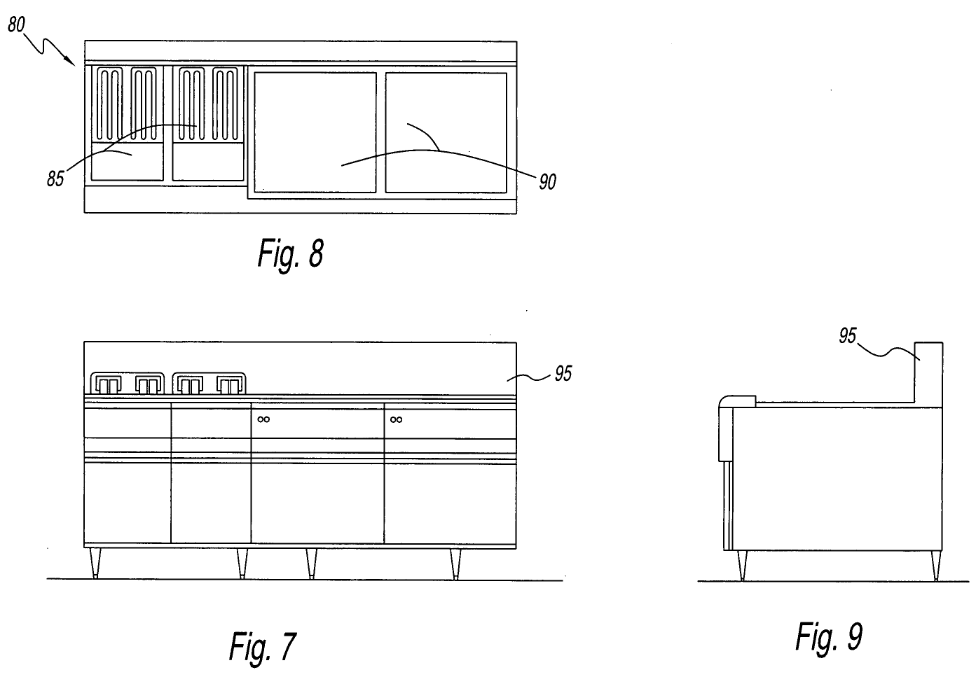

Referring to FIGS. 7 through 9 of the present invention, a second embodiment of fryers 80 are shown incorporated two different types of fry pots 85 and 90 into a single cabinet structure 95. In this embodiment, two electric fryers 85 are adjacent two flat bottom fryers 90. Electric fryers are used to cook the same lightly breaded foods as their gas counterparts. Flat bottom electric fryers are used to cook the heaviest battered foods, including fish.

Similar to the embodiment of FIGS. 1 through 5, in the embodiment of FIGS. 7 through 9, the plumbing for the drain, oil return and electronics must be combined to maximize efficiency and safety. Further, FIG. 8 shows the difference in size of the styles in the combined battery. Not only was a modification necessary to ensure that the fry pots 85 and 90 operate together, but also cabinet structure 95 was changed to achieve the unitary construction. The two smaller electric open fry pots 85 are placed against a back portion of the cabinet structure to ensure a flush even appearance of the entire cabinet structure.

That is, in a hybrid frying cabinet according to the present invention, the fry pots will align such that the smaller pots are moved towards the back of the cabinet to enable the flues to align with one another. The top cap will be expanded to provide a larger working area in front of the shorter pots.

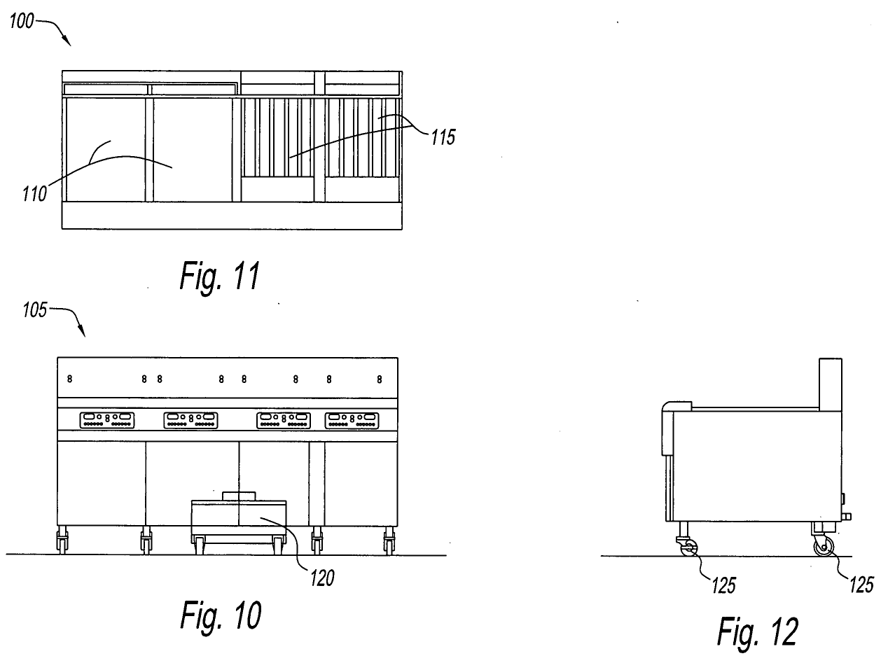

In FIGS. 10 through 12 of the present invention, a third embodiment of fryers 100 are shown incorporating two different types of fry pots into a single cabinet structure 105. In this configuration, two flat bottom fryers 110 are adjacent to two tube fryers 115 in single cabinet structure 105. Flat bottom fryers are used to cook the heaviest wet battered foods.

In this configuration, a separate filter pan 120 is located on casters 125 beneath the junction 130 of the two types of fry pots 110 and 115, respectively. The separate set of casters 125 are required to support the additional weight of the oil in the filter pan 120. The use of the separate filter pan 120 provides ease of removal and improved cleanability of the filtering system.

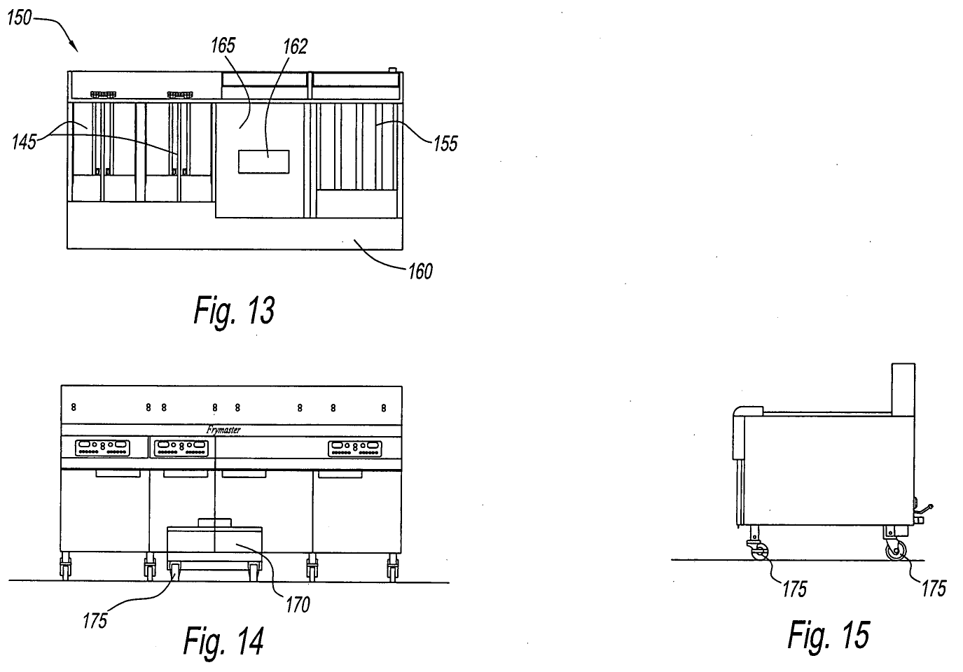

In FIGS. 13 through 15 of the present invention, a fourth embodiment of fryers 150 is shown incorporating two different types of fry pots 145 and 155 into a single cabinet structure 160. In this configuration, two open pot fryers 145 are adjacent to a work surface 165 and a tube pot fryer 155 in a single cabinet structure. Work surface 165 allows a food service worker to prepare food in close proximity to the fryer pots 145 and 155. Work surface 165 can also have a recess 162 into which debris from the work surface is deposited. Although work a single work surface 165 is shown, multiple work surfaces could also be used.

In this configuration, a separate filter pan 170 is movable on casters 175. Filter pan 170 is positioned in a location that is central to the two types of fry pots 145 and 155, respectively. The separate set of casters 175 are required to support the additional weight of the oil in the filter pan 170. The use of the separate filter pan 170 provides ease of removal and improved cleanability of the filtering system.

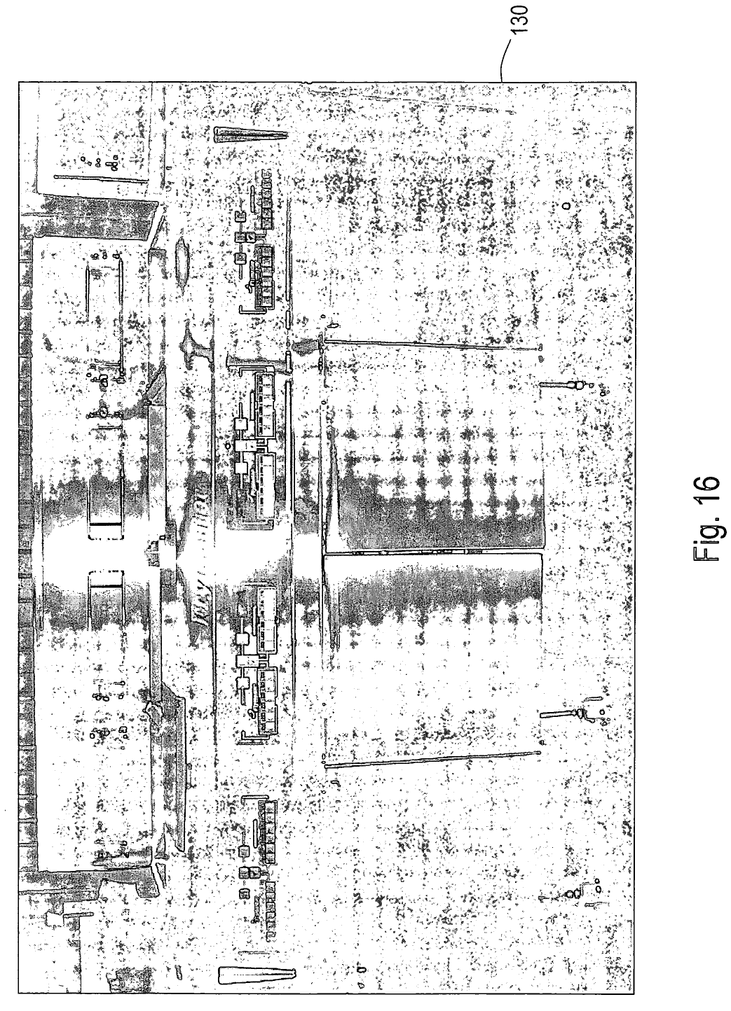

FIG. 16 shows a fifth embodiment of two different types of fryers that can also be placed in a single unitary cabinet structure.

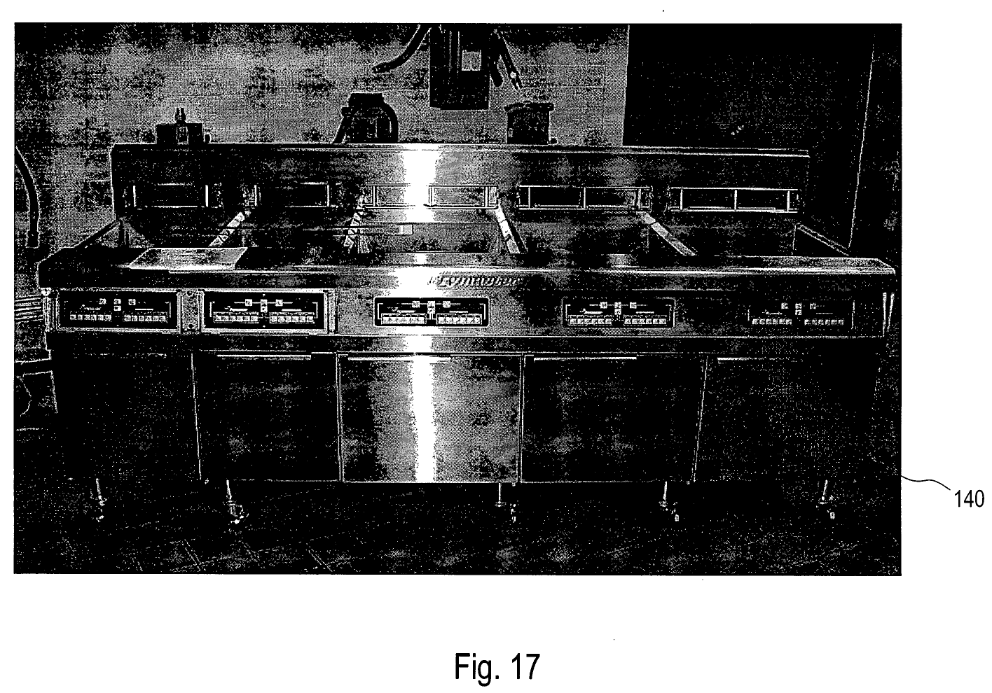

FIG. 17 shows a sixth embodiment of two different types of fryers that can be combined into a single battery to form a single unitary cabinet structure. FIG. 17 shows that five different frypots of two different types that can be combined. Any number of fry pots up to and including eight can be included into a single unitary cabinet structure. Same frypot types are adjacent in a single fryer battery. Thus, this invention has applicability from small to large commercial dining establishments.

Additionally, the single unitary cabinet structure of this invention can include any combination of the following types of fryers: open pot fryers, tube fryers, flatbottom fryers, pressure fryers, atmospheric burner fryers, power burner type fryers and electric fryers.

While the instant disclosure has been described with reference to one or more exemplary embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this invention, but that the invention will include all embodiments falling within the scope of the appended claims.

1. A unitary housing for food preparation comprising:
a plurality of types of food fryers operably connected in said unitary housing wherein said housing is configured to integrate each of said plurality of types of food fryers into said unitary housing.

2. The unitary housing of claim 1, wherein each of said plurality of food fryers share a filter, an electronic system and a plumbing system.

3. The unitary housing of claim 2, wherein said plumbing system comprises an oil return manifold.

4. The unitary housing of claim 1, further comprising a uniform cabinet structure at a front portion of said housing.

5. The unitary housing of claim 1, further comprising casters connected to said housing.

6. The unitary housing of claim 1, wherein said food fryers are selected from the group consisting of open pot fryers, tube fryers, flatbottom fryers, pressure fryers, atmospheric burner fryers, power burner fryers and electric fryers.

7. The unitary housing of claim 1, further comprising at least one work surface operably connected in said unitary housing.

8. The unitary housing of claim 7, further comprising at least one recess in said at least one work surface for receiving debris from said work surface.

9. A unitary housing system for food preparation comprising:
a plurality of types of food fryers and at least one work surface operably connected in said unitary housing; and
a filter pan positioned for operation with each of said plurality of types of food fryers
wherein said unitary housing system is configured to integrate each of said plurality of types of food fryers and said at least one work surface into said unitary housing system.

10. The unitary housing system of claim 9, wherein said filter pan is movable beneath said housing on casters.

11. The unitary housing system of claim 9, wherein each of said plurality of food fryers share said filter pan, an electronic system and a plumbing system.

12. The unitary housing system of claim 11, wherein said plumbing system comprises an oil return manifold.

13. The unitary housing system of claim 9, further comprising a uniform cabinet structure at a front portion of said housing system.

14. The unitary housing system of claim 9, further comprising casters connected to said housing system.

15. The unitary housing system of claim 9, wherein said food fryers are selected from the group consisting of open pot fryers, tube fryers, flatbottom fryers, pressure fryers, atmospheric burner fryers, power burner fryers and electric fryers.

16. The unitary housing system of claim 9, wherein said at least one work surface further comprises a recess for receiving debris from said at least one work surface.
